(19) United States
(12) Patent Application Publication
(10) Pub. No.: US 2014/0171164 A1
(43) Pub. Date: Jun. 19, 2014

(54) Concave for Rotary Combine

(71) Applicants: Gerald A. Foster, Sunnybrook (CA); Dale W. MacKenzie, Sunnybrook (CA)

(72) Inventors: Gerald A. Foster, Sunnybrook (CA); Dale W. MacKenzie, Sunnybrook (CA)

(73) Assignee: Kondex Corporation, Lomira, WI (US)

(21) Appl. No.: 14/107,868

(22) Filed: Dec. 16, 2013

(30) Foreign Application Priority Data
Dec. 17, 2012 (CA) 2799990

(51) Int. Cl. A01F 12/26

(52) U.S. Cl. CPC A01F 12/26
USPC 460/107

(57) ABSTRACT

There is provided a concave for a rotary combine which includes a body having a plurality of curved frame sections connected in parallel side by side relation. Each of the curved frame section has having ends and sides. The body has an entry end and an exit end. Each of the curved frame sections has a face with an upstanding crop processing profile. For the curved frame sections at the entry end of the body the crop processing profile is a threshing profile having an orientation extending between the sides. For the curved frame sections at the exit end of the body the crop processing profile is a separation profile of sine wave vanes having an orientation extending toward the ends and having apertures positioned between the vanes to permit passage of grain.

### CROSS-REFERENCE TO RELATED PATENT APPLICATIONS

This patent application claims the benefit of Canadian Patent Application No. 2,799,990, filed Dec. 17, 2012, the entire teachings and disclosure of which are incorporated herein by reference thereto.

### FIELD OF THE INVENTION

There is described a concave for a rotary combine.

### BACKGROUND OF THE INVENTION

A rotary combine has one or more stationary portions referred to as a “concave” and a rotating portion referred to as a “rotor” or “beater” in the form of revolving tine separators or raspbars. The tine separators of the beater penetrate and comb a crop mat which rests against the concave helping release grain that is trapped in the straw. There will hereinafter be described an improved concave structure.

### BRIEF SUMMARY OF THE INVENTION

There is provided a concave for a rotary combine which includes a body having a plurality of curved frame sections connected in parallel side by side relation. Each of the curved frame section has having ends and sides. The body has an entry end and an exit end. Each of the curved frame sections has a face with an upstanding crop processing profile. For the curved frame sections at the entry end of the body the crop processing profile is a threshing profile having an orientation extending between the sides. For the curved frame sections at the exit end of the body the crop processing profile is a separation profile of sine wave vanes having an orientation extending toward the ends and having apertures positioned between the vanes to permit passage of grain.

The concave described above has been determined to provide a number of advantages over prior art concave structures. Some concave structures have crop processing profiles that do not effectively separate grain from straw. This results in financial loss as grain passes through the combine exiting with the straw. The sine wave vane separation profile has been found to be very effective in achieving separation of the grain from the straw. It functions like a sine wave to move the crop back and forth “shaking” the crop to achieve separation. Some concave structures use very aggressive crop processing profiles, which achieve desired separation but in the process of doing so cut the straw to such an extent that the straw can no longer be properly formed into bales. The sine wave vane separation profile has been found to achieve the desired separation without limiting the length of the straw.

One of the advantages of the sine wave or sine wave profile, is that one may experiment with the amplitude and frequency of the sine wave profile, in combination with the aperture size and layout to adapt the profile to various types of crops.

While the proportion of threshing profile to separation profile may vary with application, for most applications it is preferred that a ratio be achieved where for a first third of the body the curved frame sections have the threshing profile and for a second two thirds of the body the curbed frame sections have the separation profile. There is a variety of known threshing profiles that can be used, such as bars extending between the sides of the concave sections.

In order to allow the flexibility to alter the proportions of the threshing profiles and the separation profiles, it is preferred that a modular approach be used. In accordance with this aspect of the invention, each curved frame section has a plurality of pockets and each of the pockets has a first coupling. The face with the upstanding crop processing profile is positioned on a plurality of tiles. Each of the plurality of tiles has a second coupling configured to be secured with removable fasteners to the first coupling thereby securing each tile in one of the plurality of pockets of one of the curved frame sections.

Another aspect is directed toward a concave for a rotary combine with at least two crop processing profiles with diverging vane configurations. The concave comprises body having ends and sides, the body having an entry end and an exit end, and a first side and second side on opposite sides of the body that extend between the entry end and the exit end; each of the curved frame sections having a face with an upstanding crop processing profile. For the curved frame sections proximate the entry end of the body a first crop processing profile has an orientation extending between the sides. The first crop processing profile comprises first vanes. For the curved frame sections proximate the exit end of the body a second crop processing profile has an orientation extending between the sides. The second crop processing profile comprises second vanes and having apertures positioned between the vanes to permit passage of grain. The first vanes extend transverse relative to the sides along a first sloping path toward the inlet end and the second vanes extend transverse relative to the sides along a second sloping path toward the outlet end. The first sloping path diverging away from second sloping path.

In some configurations the diverging path can be configured to control crop speed, grain separation and threshing impact. For example, greater threshing and slower speed may occur at the front end, while increased speed, separation and stretching of crop material may occur at the back end.

Further, profiles that speed up at the back end may do one or more of the following: increase throughput, decrease wear and/or power requirements and/or increase grain separation.

A feature can be that a division extends transversely between the first crop processing profile and the second crop processing profile. For example, the division may be a parting line between abutting insert tiles, or may be alternatively a divider bar of a frame section or can be intervening sections, profiles or insert tiles. Relative to vane configuration, the first sloping path extends away from the division as the first vanes extend from the first side toward the second side and from the division toward the inlet end; and the second sloping path extends away from the division as the second vanes extend from the first side toward the second side and from the division toward the exit end.

In one embodiment, the first crop processing profile and the second crop processing profile each start immediately on opposite flanks of the division.

In one embodiment, the first crop processing profile and the second crop processing profiles can be provided by a plurality of removable insert tiles. The body comprises a plurality of curved frame sections connected in parallel side by side relation, the removable insert tiles being fastened into pockets within the curved frame sections.

Where removable insert tiles are used, they may include a curved threshing face and mounting flanges on opposed sides of the curved threshing face projecting away from the curved threshing face. The first or second vanes project from the curved threshing face in a direction opposite the mounting flanges. The threshing face optionally includes apertures formed therethrough for grain passages.

In one embodiment, the first vanes extend along a linear path, and wherein the second vanes extend along a interrupted path comprising an intermediate vane segment between outer vane segments, the intermediate vane segment being flatter in slope as compared to the outer vane segments.

In an embodiment, the interrupted path provides a sine wave profile.

The first crop processing profile can also comprises a plurality of apertures positioned between the first vanes to permit passage of grain.

In an embodiment, the first crop processing profile includes apertures positioned between the vanes to permit passage of grain, but the second crop processing profile includes at least twice as many apertures per unit of area.

The first crop processing profile may be utilized between ⅙ and ⅔ of the upstanding crop processing profile; and the second crop processing profile may be utilized between ⅚ and ⅓ of the upstanding crop processing profile.

Another aspect of the present invention is directed toward a rotary combine including a concave. The combine comprises a rotor received along the concave wherein the face of the concave faces an outer peripheral surface of the rotor. The outer peripheral surface of the rotor includes crop drive elements arranged to impart spiral movement to crop moved along the concave. The spiral path impacts first vanes substantially perpendicularly within 30 degrees of perpendicular, and impacts the second vanes in a later stage at an average angle less than 45 degrees. During operation and rotation of the rotor relative to the concave, crop impacts the first vanes substantially perpendicular slowing the crop to thresh the crop, and impacts the second vanes more in line thereby speeding up crop flow relative to the first vanes and facilitating separation of crop and grain.

A method of threshing and separating grain from crop material employing the rotary combine can comprise: rotating the rotor relative to the concave to generate a spiral flow of crop material along the concave; threshing and slowing the spiral flow the crop material along the first crop processing profile; and separating and speeding and stretching out the spiral flow of the crop material along the second crop processing profile to facilitate grain separation.

Another aspect of the present invention includes a method of threshing and separating grain from crop material employing a rotary combine, the rotary combine comprising a rotor received along the concave wherein the face of the concave faces an outer peripheral surface of the rotor, the outer peripheral surface including crop drive elements arranged to impart spiral movement to crop moved along the concave, The method comprises: rotating the rotor relative to the concave to generate a spiral flow of crop material along the concave; threshing and slowing the spiral flow the crop material along a first crop processing profile; and separating and speeding and stretching out the spiral flow of the crop material along a second crop processing profile to facilitate grain separation.

In an embodiment, the first crop processing profile and the second crop processing profile may have differently configured vanes, first vanes of the first crop processing profile impacting the crop material to a greater amount than second vanes of the second crop processing profile.

In an embodiment the second vanes of the first crop processing profile impact the crop material to a greater amount than second vanes of the second crop processing profile.

The concave may include apertures in the first crop processing profile and the second crop processing profile. The apertures are positioned between vanes to permit passage of grain.

In an embodiment, the second crop processing profile can includes at least twice as many apertures per unit of area than the first crop processing profile.

Other aspects, objectives and advantages of the invention will become more apparent from the following detailed description when taken in conjunction with the accompanying drawings.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a concave for a rotary combine comprised of a plurality of concave sections.

FIG. 2 is a top plan view of one of the concave section illustrated in FIG. 1.

FIG. 3 is a perspective view of a tile insert with a threshing profile used in the concave sections illustrated in FIG. 1.

FIG. 4 is a top plan view of a tile insert with a separation profile used in the concave sections illustrated in FIG. 1.

FIG. 5 is a perspective and partly schematic illustration of the insert tiles arranged in a configuration from inlet end toward outlet end with a division located between to illustrate a diverging configuration.

FIG. 6 is a perspective and partly schematic view of a combine that is cut away to show the rotor and concave.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

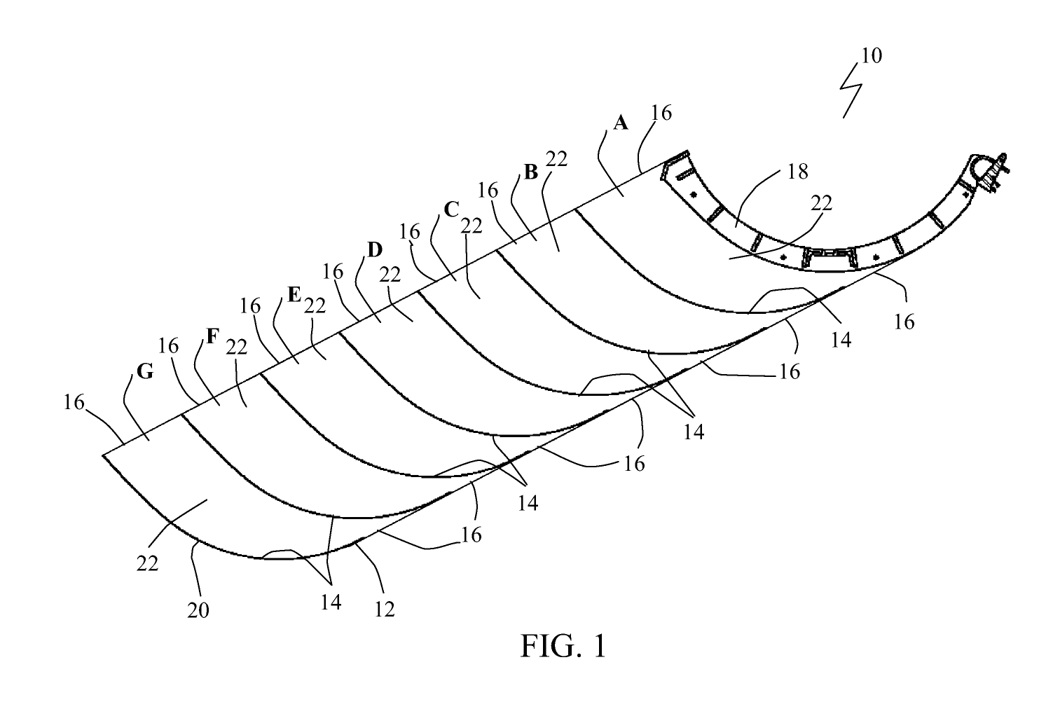

A concave for a rotary combine generally identified by reference numeral 10, will now be described with reference to FIG. 1 through 4.

### Structure and Relationship of Parts:

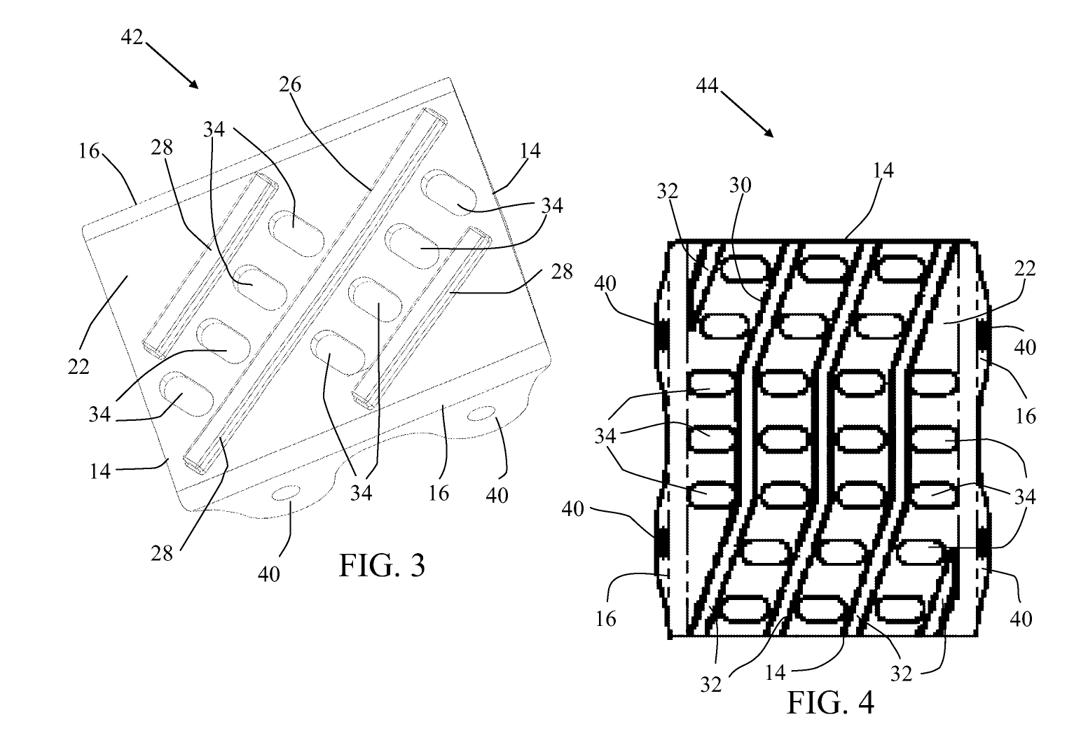

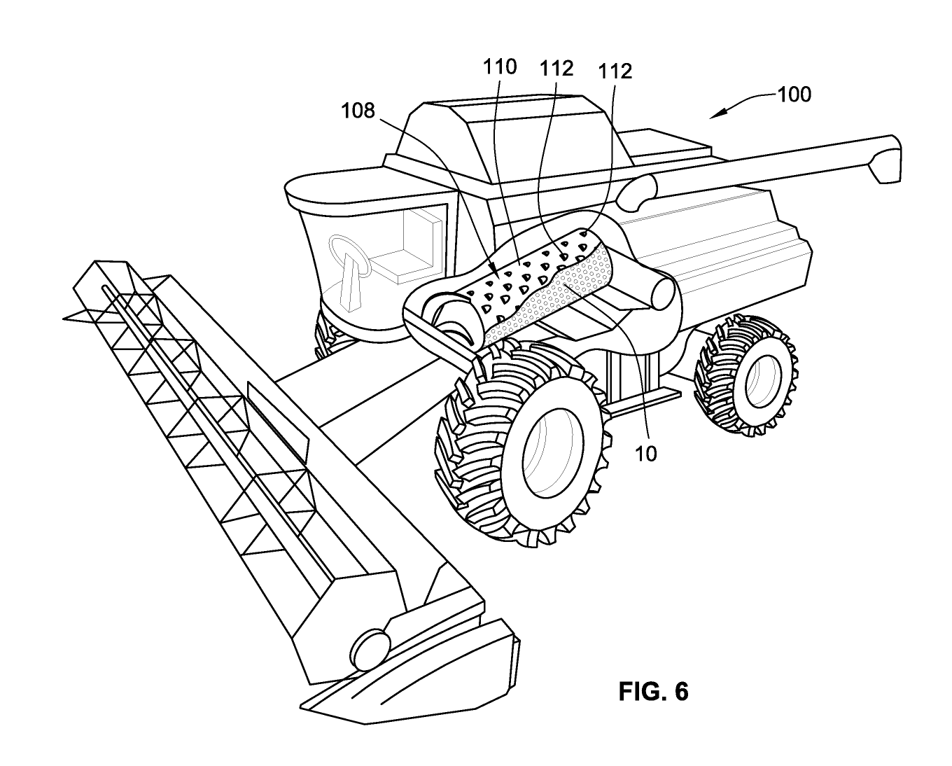

Referring to FIG. 1, a concave 10 for a rotary combine 100 (FIG. 6) includes a body 12 with a plurality of curved frame sections A through G connected in parallel side by side relation. In the embodiment shown, seven curved frame sections A through G are connected in parallel side by side relation, however it will be understood that a different number of curved frame sections may be used. Referring to FIGS. 3 and 4, each curved section A through G has ends 14 and sides 16 and, referring to FIG. 1, body 12 has an entry end 18 and an exit end 20. Referring to FIGS. 3 and 4, each of curved frame sections, A through G, has a face 22 with an upstanding crop processing profile. Referring to FIG. 3, an entry end 18 of body, crop processing profile 24 of curved frame sections A and B is a threshing profile 26 with an orientation extending between the sides 16. A variety of different threshing profiles 26 may be used, however it is preferred that threshing profile 26 have bars 28 (also referred to as “vanes”) that extend between sides 16. Referring to FIG. 4, at exit end 20 of body 12, crop processing profile 24 of curved frame section C through G is a separation profile 30 with sine wave vanes 32. Sine wave vanes 32 have an orientation extending toward the ends 14 and have apertures 34 positioned between vanes 32 to permit passage of grain.

The threshing profile 26 strikes the incoming crop and in doing so dislodges the grain from the straw. The grain and straw continue through the machine intermingled. The sine wave vanes 32 have been found to be very effective in achieving separation of grain from straw. It functions like a sine wave to move the crop back and forth, “shaking” the straw to achieve separation of the grain without chopping or otherwise limiting the length of the straw. The amplitude and frequency of the sine wave vanes 32, along with aperture 34 size adapt the profile 30 to various types of crops with differing sizes of grain.

Referring to FIG. 1, it is preferred that the first third of body 12 has curved frame sections A and B with the threshing profile 26 and the remaining two thirds of body 12 has curved frame sections C through G with a separation profile 30. It will, however, be understood that threshing profile 26 and separation profile 30 may occupy different proportions of body 12.

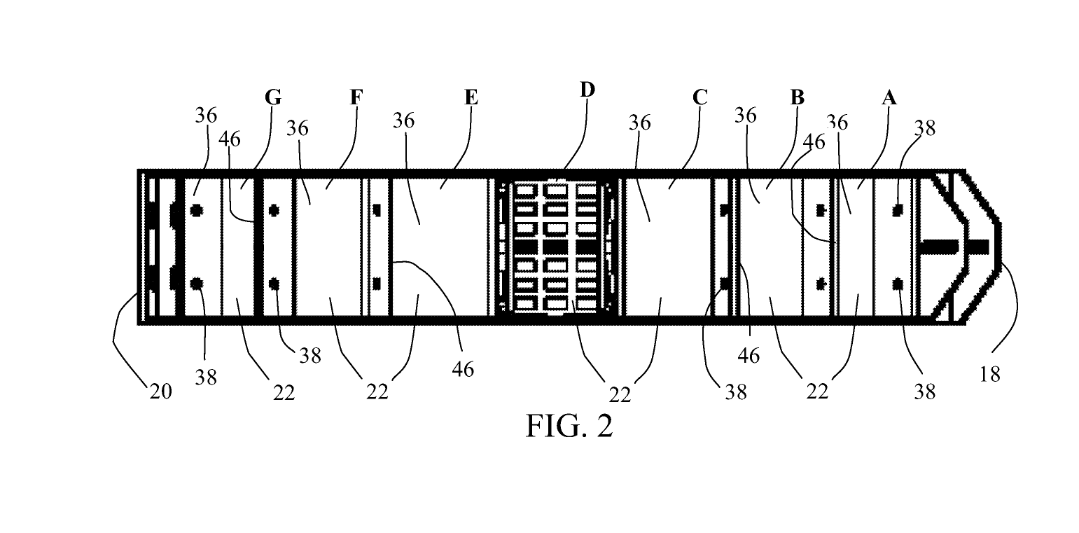

In order to allow the flexibility to alter the proportions of threshing profiles 26 and separation profiles 32, it is preferred that a modular approach be used. Each curved frame section A through G has a plurality of pockets 36 and each of pockets 36 has a first coupling 38. Referring to FIG. 3, tiles 42 with a threshing profile 26 and, referring to FIG. 4, tiles 44 with a separation profile 32 are provided to create the desired crop processing profile 24 along curved frame sections A through G. Dividers 46 provide proper spacing and positioning of tiles 42 and 44 on curved frame sections A through G. Referring to FIGS. 3 and 4, each of the plurality of tiles 42 and 44 has a second coupling 40 configured to be secured with removable fasteners, not shown, to first coupling 38 thereby securing each tile 42 and 44 in one of the plurality of pockets 36 of one of curved frame sections A through G. Referring to FIG. 2, dividers 46 are used to anchor tiles 42 and 44, shown in FIGS. 3 and 4, within body 12. Removable fasteners pass through dividers 46 to hold tiles 42 and 44 in body 12.

### Operation:

Referring to FIG. 1, curved frame sections A through G are positioned in parallel spaced relation. The number of curved frame sections may be increased or decreased to lengthen or shorten body 12 and lengthen or shorten the threshing and separation stages in a rotary combine. In the present embodiment, curved sections A and B have threshing profile which are used to dislodge grain from straw before it reaches curved sections C through G which have separation profiles which separate the grain from straw. Referring to FIG. 4, sine wave vanes 32 move the crop back and forth, “shaking” the straw crop to achieve separation of the grain without limiting the length of the straw. The amplitude and frequency of the sine wave vanes 32, may be selected to be particularly suited to various types of crops. Separated grain falls through apertures 34 where it is collected while straw continues to exit end 20 of body 12. It will be understood that different proportions of body 12 may have threshing profile 26 and separation profile 30. Where modular tiles are used, the proportion of threshing profile 26 to separation profile 30 may be easily altered by attaching and removing tiles with the appropriate crop processing profile. Referring to FIGS. 3 and 4, second coupling 40 on tiles are secured with removable fasteners to first coupling 38, shown in FIG. 1.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

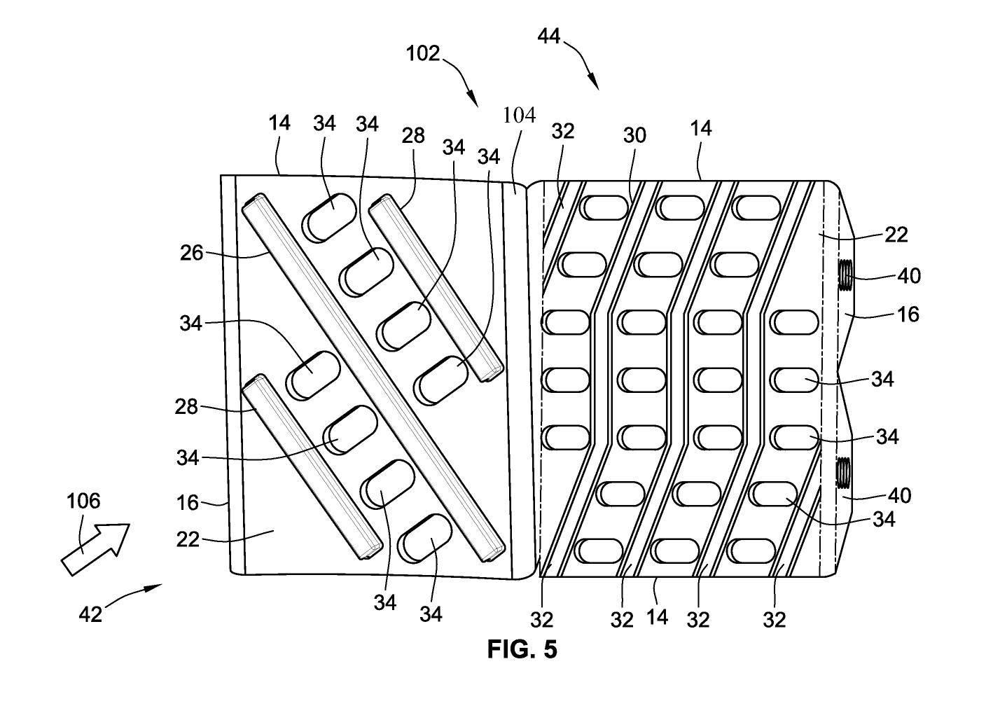

Turning to FIG. 5, an assembly 102 of the removable insert tiles 42, 44 are shown in orientation as employed in a concave with the left hand side being closer to the inlet end and the right hand side being closer to the outlet end of the concave. Where the profiles switch from one type of profile to another profile type (e.g. the threshing vanes or bars 28 to the sine wave vanes 32) may be referred to as a division 104, which may generally be the interface between two profiles as shown, or may be alternatively a divider bar of a frame section or can be intervening sections, profiles or insert tiles. Often the division may be defined by different frame sections A-G and some frame sections may be dedicated to one profile and other sections dedicated to another profile.

The first crop processing profile such as in removable insert tiles 42 may be utilized between ⅙ and ⅔ of the upstanding crop processing profile; and the second crop processing profile such as provided in removable insert tiles 44 may be utilized between ⅚ and ⅓ of the upstanding crop processing profile.

As shown in FIG. 5, the first vanes (bars 28) extend transverse relative to the sides along a first sloping path toward the inlet end and the second vanes (sin wave vanes 32) extend transverse relative to the sides along a second sloping path toward the outlet end. The first sloping path diverging away from second sloping path. Relative to vane configuration, the first sloping path extends away from the division as the first vanes extend from the first side toward the second side and from the division toward the inlet end; and the second sloping path extends away from the division as the second vanes extend from the first side toward the second side and from the division toward the exit end.

With this configuration, the crop material will engage the concave and the profiles as shown in FIG. 5 approximately at a crop impact angle 106 due to the spiral motion imparted from a drive rotor 108 in such rotary combine 100 including the concave 10 as depicted in FIG. 6. The combine comprises a rotor received along the concave wherein the face of the concave 10 faces an outer peripheral surface 110 of the rotor 108. The outer peripheral surface 110 of the rotor 108 includes crop drive elements 112 arranged to impart spiral movement to crop moved along the concave 10.

Referring again in conjunction with FIG. 5, the spiral path impacts first vanes (bars 28) substantially perpendicularly within 30 degrees of perpendicular, and impacts the second vanes (sin wave vanes 32) in a later stage at an average angle less than 45 degrees and thereby more in line with the vanes rather than cross-wise with the vanes. During operation and rotation of the rotor 108 relative to the concave 10, crop impacts the first vanes substantially perpendicular slowing the crop to thresh the crop, and impacts the second vanes more in line thereby speeding up crop flow relative to the first vanes and facilitating separation of crop and grain.

With this and the diverging path of the vanes of different tiles shown in FIG. 5, the arrangement is configured to control crop speed, grain separation and threshing impact. For example, with this configuration greater threshing and slower speed occurs at the front end, while increased speed, separation and stretching of crop material occurs at the back end during operations.

The scope of the claims should not be limited by the illustrated embodiments set forth as examples, but should be given the broadest interpretation consistent with a purposive construction of the claims in view of the description as a whole.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A concave for a rotary combine, comprising:
a body comprised of a plurality of curved frame sections connected in parallel side by side relation, each curved frame section having ends and sides, the body having an entry end and an exit end; and
each of the curved frame sections having a face with an upstanding crop processing profile, for the curved frame sections at the entry end of the body the crop processing profile is a threshing profile having an orientation extending between the sides and for the curved frame sections at the exit end of the body the crop processing profile is a separation profile comprised of sine wave vanes having an orientation extending toward the ends and having apertures positioned between the vanes to permit passage of grain.

2. The concave of claim 1, wherein for a first third of the body the curved frame sections have the threshing profile and for a second two thirds of the body the curbed frame sections have the separation profile.

3. The concave of claim 1, wherein the threshing profile is comprised of bars extending between the sides.

4. The concave of claim 1, wherein
each curved frame section has a plurality of pockets and each of the pockets has a first coupling; and
the face with the upstanding crop processing profile is positioned on a plurality of tiles, each of the plurality of tiles a second coupling configured to be secured with removable fasteners to the first coupling thereby securing each tile in one of the plurality of pockets of one of the curved frame sections.

5. A concave for a rotary combine, comprising:
a body having ends and sides, the body having an entry end and an exit end, and a first side and second side on opposite sides of the body that extend between the entry end and the exit end;
each of the curved frame sections having a face with an upstanding crop processing profile,
for the curved frame sections proximate the entry end of the body a first crop processing profile has an orientation extending between the sides, the first crop processing profile comprises first vanes;
for the curved frame sections proximate the exit end of the body a second crop processing profile has an orientation extending between the sides, the second crop processing profile comprises second vanes and having apertures positioned between the vanes to permit passage of grain;
wherein the first vanes extend transverse relative to the sides along a first sloping path toward the inlet end and second vanes extend transverse relative to the sides along a second sloping path toward the outlet end, the first sloping path diverging away from second sloping path.

6. The concave of claim 5, wherein a division extends transversely between the first crop processing profile and the second crop processing profile, wherein the first sloping path extends away from the division as the first vanes extend from the first side toward the second side and from the division toward the inlet end; and wherein the second sloping path extends away from the division as the second vanes extend from the first side toward the second side and from the division toward the exit end.

7. The concave of claim 6, wherein the first crop processing profile and the second crop processing profile each start immediately on opposite flanks of the division.

8. The concave of claim 5, wherein the first crop processing profile and the second crop processing profiles are provided by a plurality of removable insert tiles, and wherein the body comprises a plurality of curved frame sections connected in parallel side by side relation, the removable insert tiles being fastened into pockets within the curved frame sections.

9. The concave of claim 8, wherein each removable insert tile includes a curved threshing face and mounting flanges on opposed sides of the curved threshing face projecting away from the curved threshing face, the first or second vanes projecting from the curved threshing face in a direction opposite the mounting flanges, and wherein the threshing face optionally includes apertures formed therethrough.

10. The concave of claim 5, wherein the first vanes extend along a linear path, and wherein the second vanes extend along a interrupted path comprising an intermediate vane segment between outer vane segments, the intermediate vane segment being flatter in slope as compared to the outer vane segments.

11. The concave of claim 9, wherein the interrupted path provides a sine wave profile.

12. The concave of claim 5, wherein the first crop processing profile comprises a plurality of apertures positioned between the first vanes to permit passage of grain.

13. The concave of claim 5, wherein the first crop processing profile includes apertures positioned between the vanes to permit passage of grain, the second crop processing profile includes at least twice as many apertures per unit of area.

14. The concave of claim 5, wherein the first crop processing profile is utilized between ⅙ and ⅔ of the upstanding crop processing profile; and the second crop processing profile is utilized between ⅚ and ⅓ of the upstanding crop processing profile.

15. A rotary combine including the concave of claim 5, comprising a rotor received along the concave wherein the face of the concave faces an outer peripheral surface of the rotor, the outer peripheral surface including crop drive elements arranged to impart spiral movement to crop moved along the concave, wherein the spiral path impacts the first vanes substantially perpendicularly within 30 degrees of perpendicular, and wherein the spiral path impacts the second vanes at an average angle less than 45 degrees, wherein during operation and rotation of the rotor relative to the concave crop impacts the first vanes substantially perpendicular slowing the crop to thresh the crop, and impacts the second vanes more in line thereby speeding up crop flow relative to the first vanes and facilitating separation of crop and grain.

16. A method of threshing and separating grain from crop material employing the rotary combine of claim 14, comprising:
rotating the rotor relative to the concave to generate a spiral flow of crop material along the concave;
threshing and slowing the spiral flow the crop material along the first crop processing profile; and
separating and speeding and stretching out the spiral flow of the crop material along the second crop processing profile to facilitate grain separation.

17. A method of threshing and separating grain from crop material employing a rotary combine, the rotary combine comprising a rotor received along the concave wherein the face of the concave faces an outer peripheral surface of the rotor, the outer peripheral surface including crop drive elements arranged to impart spiral movement to crop moved along the concave, comprising:
rotating the rotor relative to the concave to generate a spiral flow of crop material along the concave;
threshing and slowing the spiral flow the crop material along a first crop processing profile; and
separating and speeding and stretching out the spiral flow of the crop material along a second crop processing profile to facilitate grain separation.

18. The method of claim 17, wherein the first crop processing profile and the second crop processing profile have differently configured vanes, first vanes of the first crop processing profile impacting the crop material to a greater amount than second vanes of the second crop processing profile.

19. The method of claim 18, wherein second vanes of the first crop processing profile impacting the crop material to a greater amount than second vanes of the second crop processing profile.

20. The method of claim 17, further comprising apertures in the first crop processing profile and the second crop processing profile, the apertures positioned between vanes to permit passage of grain, wherein the second crop processing profile includes at least twice as many apertures per unit of area than the first crop processing profile.
